(19) United States
(12) Patent Application Publication
(10) Pub. No.: US 2026/0187501 A1
(43) Pub. Date: Jul. 2, 2026

(54) VERIFICATION DEVICE, INFERENCE SYSTEM, VERIFICATION METHOD, AND NON-TRANSITORY COMPUTER-READABLE STORAGE MEDIUM

(71) Applicant: Mitsubishi Electric Corporation, Tokyo (JP)

(72) Inventor: Genta YOSHIMURA, Tokyo (JP)

(73) Assignee: Mitsubishi Electric Corporation, Tokyo (JP)

(21) Appl. No.: 19/543,402

(22) Filed: Feb. 18, 2026

Related U.S. Application Data
(63) Continuation of application No. PCT/JP2023/034187, filed on Sep. 21, 2023.

(51) Int. Cl. G06N 5/04

(52) U.S. Cl. CPC G06N 5/04

(57) ABSTRACT

A verification device includes: an expected output determining unit to determine whether or not all output data of an inference model for an input data area is in violation that the output data is not an expected output; an input area dividing unit to divide an area determined not to be in violation in the input data area and set a divided area as the input data area that is new of the inference model; an area ratio calculating unit to calculate a ratio of an area for each of determination results with respect to the input data area; and a display processing unit to display verification result information indicating the ratio of the area on a display device.

### CROSS REFERENCE TO RELATED APPLICATION

This application is a Continuation of PCT International Application No. PCT/JP 2023/034187, filed on Sep. 21, 2023, which is hereby expressly incorporated by reference into the present application.

### TECHNICAL FIELD

The present disclosure relates to a verification device, an inference system, a verification method, and non-transitory computer-readable storage medium.

### BACKGROUND ART

A technique for evaluating validity of an inference model that is a machine learning model has been proposed. For example, Patent Literature 1 presents an area including at least one violation data sample that violates the verification property among model output areas for data areas input to the decision tree ensemble model.

### CITATION LIST

### Patent Literature

Patent Literature 1: Japanese Patent No. 7059220

### SUMMARY OF INVENTION

### Technical Problem

The conventional technique described in Patent Literature 1 presents a range including at least one violation data sample that is not an expected output of an inference model, but there is no guarantee that all data samples in the presented range are violation data samples. For this reason, the conventional technique has a problem that, for example, when the violation data sample is not present in most areas within the presented range and the violation data sample is present only in a very narrow area, the degree of the violation is overestimated, and it is difficult to appropriately deal with the violation.

The present disclosure solves the above problem, and an object thereof is to obtain a verification device capable of presenting a ratio of an input data area for each determination result of an expected output of an inference model.

### Solution to Problem

A verification device according to the present disclosure includes: processing circuitry: to determine whether or not all output data of an inference model for an input data area that is a numerical range of data is in violation that the output data is not an expected output; a to divide an area determined not to be in violation in the input data area and set a divided area as the input data area that is new of the inference model; a to calculate a ratio of an area for each of determination results with respect to the input data area; and to output verification result information indicating the ratio of the area.

### Advantageous Effects of Invention

According to the present disclosure, it is determined whether or not all output data of an inference model for an input data area is in violation that the output data is not an expected output, an area determined not to be in violation in the input data area is divided, a divided area is set as the input data area that is new of the inference model, a ratio of an area for each of determination results with respect to the input data area is calculated, and verification result information indicating the ratio of the area is output. By outputting the ratio of the area for each determination result of the expected output of the inference model, the verification device according to the present disclosure can present the ratio of the input data area for each determination result of the expected output of the inference model. Thus, it is possible to suppress the degree of violation from being overestimated or underestimated.

### BRIEF DESCRIPTION OF DRAWINGS

FIG. 1 is a block diagram illustrating a configuration example of an inference system according to a first embodiment.

FIG. 2 is a graph illustrating determination results of an input data area and an expected output.

FIG. 3 is a schematic diagram illustrating division processing of an input data area and an expected output determination result.

FIG. 4 is a schematic diagram illustrating an outline of expected output determination.

FIG. 5 is a diagram illustrating an example of the expected output determination result.

FIGS. 6A, 6B, and 6C are diagrams illustrating display examples of verification results.

FIG. 7 is a flowchart illustrating a verification method according to the first embodiment.

FIG. 8 is a flowchart illustrating area determination processing.

FIGS. 9A and 9B are block diagrams illustrating a hardware configuration that implements functions of the verification device according to the first embodiment.

FIG. 10 is a block diagram illustrating a configuration example of an inference system according to a second embodiment.

FIG. 11 is a diagram illustrating an acquisition result of a data area of an expected output determination result and a display example thereof.

FIG. 12 is a diagram illustrating an acquisition result of a data sample from the data area of the expected output determination result and a display example thereof.

FIG. 13 is a schematic diagram illustrating a display example of an area on which summarization has been performed.

### DESCRIPTION OF EMBODIMENTS

### First Embodiment

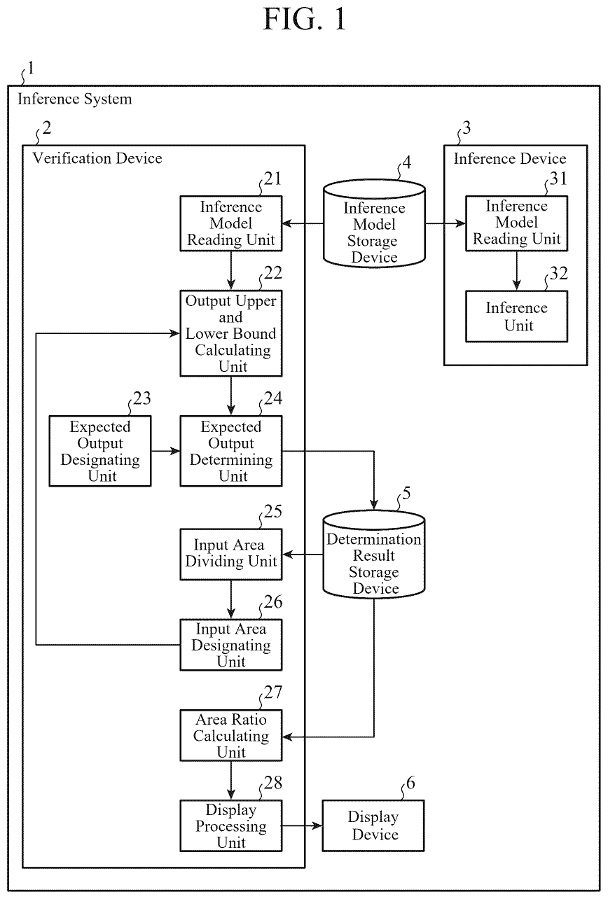

FIG. 1 is a block diagram illustrating a configuration example of an inference system 1 according to a first embodiment. In FIG. 1, an inference system 1 is a system that performs inference using a verified inference model, and includes a verification device 2, an inference device 3, an inference model storage device 4, a determination result storage device 5, and a display device 6. The verification device 2 is a device that verifies an inference model that is a machine learning model, and the inference device 3 is a device that performs inference using the inference model. The inference system 1 is a system in which the verification device 2, the inference device 3, the inference model storage device 4, the determination result storage device 5, and the display device 6 are connected via a wired signal line or a network by wireless communication. The network is, for example, a telecommunication line including the Internet or the like.

By presenting the ratio of an input data area for each determination result of an expected output of the inference model, the verification device 2 can suppress the degree of violation from being overestimated or underestimated. For example, in a conventional technique described in Patent Literature 1, a violation range including at least one violation data sample that is not an expected output of the inference model is presented as a verification result. Note that the expected output is a proposition that is expected to be true for output data of the inference model.

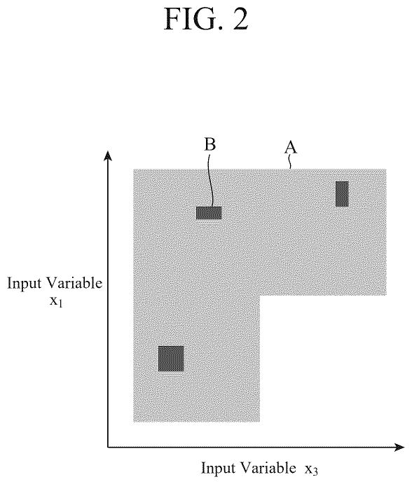

FIG. 2 is a graph illustrating a determination result of the input data area and the expected output. The input data area illustrated in FIG. 2 is a data area defined by an input variable x₁ and an input variable x₃. An area A illustrated in FIG. 2 is a data area including an area B. All the data included in the area B is a violation data sample that is not the expected output of the inference model, that is, does not satisfy the verification condition, and the area B is an area including only the violation data sample.

In the conventional technique described in Patent Literature 1, an area A may be proposed. In this area A, there is no guarantee that all data samples in the area are in violation. For example, as illustrated in FIG. 2, there may be no violation data sample in most areas, in which case the degree of violation may be overestimated.

Since there is a possibility that all the data samples are included in the violation range in the area A, output data of the inference model when the data in the area A is input is also determined not to be the expected output, that is, determined to be in violation that it does not satisfy the verification condition. In this case, although the output data of the inference model when data included in an area where the violation data sample is not present in the area A is originally the expected output, the inference is suspended.

In addition, there is a case where the output value of the inference model when the data in the area A is input is overwritten in such a manner that there is no violation. In this case, there is a possibility that the output data of the inference model when the data included in the area where the violation data sample is not present is also overwritten with another value although the output data is originally the expected output.

In addition, the inference model may be relearned by adding a data sample in the area A in such a manner that there is no violation in the output value of the inference model when the data in the area A is input. In this case, the inference behavior of the inference model when the data of the area where the violation data sample is not present in the area A is input also greatly changes.

In a case where a test is passed if the hypervolume of the violation range output from the inference model when the data included in the area A is input is equal to or less than a predetermined value, there is a possibility that the test cannot be passed even though the hypervolume of the violation range is originally equal to or less than the predetermined value because the area where the violation data sample is not present is included in the input data area.

Accordingly, the verification device 2 according to the first embodiment outputs the ratio of the area for each expected output determination result of the inference model, thereby presenting the ratio of the input data area for each determination result of the expected output of the inference model. In this manner, the verification device 2 can suppress the occurrence of a defect due to the degree of violation as described above being overestimated or underestimated.

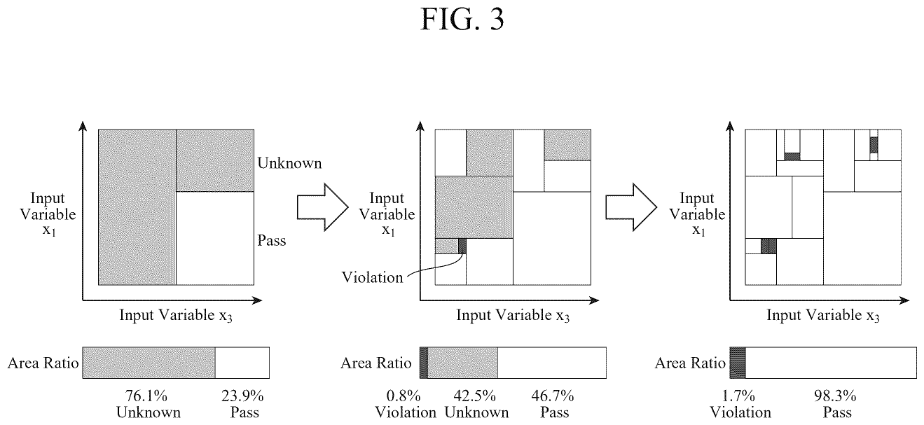

FIG. 3 is a schematic diagram illustrating the division processing of the input data area and the expected output determination result, and illustrates the input data area of the inference model defined by the input variable x₁ and the input variable x₃. In FIG. 3, an input data area including only input data with which all output data of the inference model is the expected output is a pass area. An input data area including only input data determined to be in violation that all output data of the inference model is not the expected output is a violation area. The input data area that is neither the pass area nor the violation area is an unknown area.

The verification device 2 inputs the input data area to the inference model and determines whether or not all output data of the inference model is in violation that the output data is not the expected output, thereby calculating the ratio of the area for each determination result to the input data area. As illustrated in the graph on the left side of FIG. 3, it is assumed that the ratio of the pass area at this time is 23.9% and the ratio of an unknown area is 76.1% in the input data area to the inference model. Since an unknown area, that is, an input data area in which no determination of violation has been made is included, the verification device 2 divides the unknown area as indicated by an arrow in FIG. 3 and sets the divided area as a new input data area of the inference model.

Subsequently, the verification device 2 sets each divided area of the unknown area as a new input data area of the inference model, and determines whether or not output data of the inference model is in violation that the output data is not the expected output, thereby calculating the ratio of the area for each determination result to the input data area. For example, as illustrated in the center graph of FIG. 3, it is assumed that the ratio of the pass area at this time is 46.7%, the ratio of the unknown area is 42.5%, and the ratio of the violation area is 0.8% in the input data area to the inference model. In this case, the verification device 2 determines that unknown areas are included, and further divides these unknown areas as indicated by arrows in FIG. 3.

Next, the verification device 2 sets a divided area of the newly divided unknown area as a new input data area of the inference model, and determines whether or not all output data of the inference model is in violation that the output data is not the expected output, thereby calculating the ratio of the area for each determination result to the input data area. For example, as illustrated in the graph on the right side of FIG. 3, it is assumed that the ratio of the pass area is 98.3%, the ratio of the unknown area is 0%, and the ratio of the violation area is 1.7% in the input data area to the inference model. As described above, the verification device 2 can present the ratio of the area in accordance with the expected output determination result among the input data areas for the inference model, and can also specify a data numerical range of each area. Thus, it is possible to suppress the degree of violation from being overestimated or underestimated.

The inference model storage device 4 is a storage device that stores an inference model. The inference model stored in the inference model storage device 4 is, from the viewpoint of the verification device 2, a machine learning model to be verified, and from the viewpoint of the inference device 3, is a machine learning model for inference processing. Further, the inference model storage device 4 is provided outside the verification device 2 and the inference device 3. Note that the inference model storage device 4 only needs to be accessible from the verification device 2 and the inference device 3, and may be a storage device included in a computer functioning as the verification device 2 or the inference device 3.

The determination result storage device 5 is a storage device that stores an expected output determination result of an expected output determining unit 24 included in the verification device 2. The expected output determination result is a determination result as to whether or not all the output data of the inference model for the input data area that is a numerical range of the data is in violation that the output data is not the expected output.

Further, the determination result storage device 5 is provided outside the verification device 2. Note that the determination result storage device 5 only needs to be accessible from the verification device 2, and may be a storage device included in a computer functioning as the verification device 2.

The verification device 2 is implemented by, for example, a computer including a communication unit, a calculation unit, and a storage unit. The communication unit communicates with the inference model storage device 4 or the determination result storage device 5 via a wired signal line or a network by wireless communication. For example, the communication unit is a communication device capable of mobile communication by a communication system such as LTE, 3G, 4G, or 5G. In addition, the communication unit may be a short-range wireless communication unit such as Bluetooth (registered trademark).

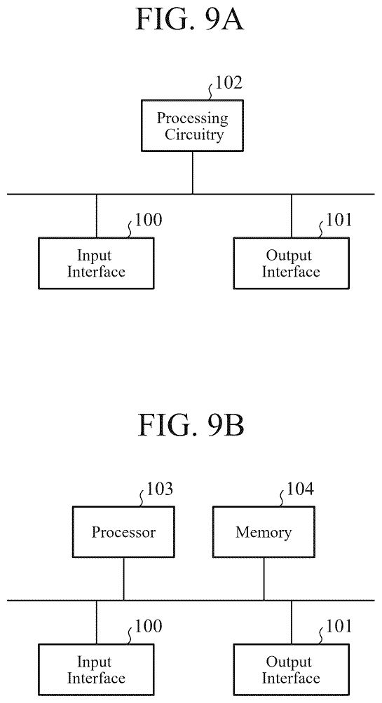

The communication unit includes an input interface 100 and an output interface 101 in FIGS. 9A and 9B.

The calculation unit controls the overall operation of the verification device 2. The calculation unit includes an inference model reading unit 21, an output upper and lower bound calculating unit 22, an expected output designating unit 23, the expected output determining unit 24, an input area dividing unit 25, an input area designating unit 26, an area ratio calculating unit 27, and a display processing unit 28. By the calculation unit executing an information processing application for verifying the inference model, various functions of the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28 are implemented. The calculation unit includes a processing circuit 102 of FIG. 9A and a processor 103 of FIG. 9B.

The storage unit stores, for example, an information processing application and information used for calculation processing of the calculation unit. The storage unit is a storage device included in a computer functioning as the verification device 2, and includes a storage such as an HDD or an SSD, a memory 104 in FIGS. 9A and 9B, or the like. Note that the storage unit only needs to be accessible by the verification device 2, and may be provided outside the verification device 2.

The inference model reading unit 21 reads the inference model to be verified from the inference model storage device 4. The inference model is a function f that returns a one-dimensional output y∈R or an M-dimensional output Y=(x₁, x₂, . . . , x_{N})∈R^{M} for an N-dimensional input X=(y₁, y₂, . . . , y_{M})∈R^{N}. Here, N and M are integers. For example, the inference model includes a trained machine learning model, a neural network, a decision tree model, a decision tree ensemble model, a support vector machine (SVM), a generalized linear model, a generalized additive model (GAM), a Gaussian process regression model (GPR), a naive Bayes model, a Gaussian mixture model (GMM), and the like.

Examples of the neural network include a multilayer perceptron (MLP), a convolutional neural network (CNN), a recurrent neural network (RNN), a Transformer, and the like. Examples of the decision tree ensemble model include a random forest, a gradient boosting tree, and the like. Examples of the generalized linear model include linear regression and logistic regression.

The output upper and lower bound calculating unit 22 calculates at least one of an upper bound or a lower bound of output data of the inference model for the input data area. That is, the inference model outputs data in which lower bound value≤output data≤upper bound value is always true.

A method of calculating the upper bound is, for example, as follows.

In a case where the inference model is a generalized linear model, the output upper and lower bound calculating unit 22 calculates, as an upper bound value, an output value when a variable having a positive coefficient takes an upper limit value of the input data area and a variable having a negative coefficient takes a lower limit value of the input data area.

In a case where the inference model is a single decision tree model, the output upper and lower bound calculating unit 22 calculates, as the upper bound value, the maximum output value among a leaf node set that can be reached by the data sample in the input data area.

In a case where the inference model is a decision tree ensemble model, the output upper and lower bound calculating unit 22 calculates, as the upper bound value, a sum of maximum output values for respective decision trees among a leaf node set that can be reached by the data sample in the input data area.

A method of calculating the lower bound is, for example, as follows.

In a case where the inference model is a generalized linear model, the output upper and lower bound calculating unit 22 calculates, as a lower bound value, an output value when a variable having a positive coefficient takes a lower limit value of the input data area and a variable having a negative coefficient takes an upper limit value of the input data area.

In a case where the inference model is a single decision tree model, the output upper and lower bound calculating unit 22 calculates, as the lower bound value, the minimum output value among a leaf node set that can be reached by the data sample in the input data area.

In a case where the inference model is a decision tree ensemble model, the output upper and lower bound calculating unit 22 calculates, as the lower bound value, a sum of minimum output values for respective decision trees among a leaf node set that can be reached by the data sample in the input data area.

The expected output designating unit 23 sets an expected output value of the inference model in the expected output determining unit 24. The expected output is a proposition that is expected to be true for output data y of the inference model. Examples thereof include designation of 50≤y<80 as a range of output value of regression, designation of 0.5≤y as a range of output score of binary classification (output of sigmoid function), designation of (y₁<y₂) & (y₃<y₂) as an output class of multi-class classification, designation of outputting class 2 by an inequality of output of a softmax function as the expected output, designation of |y−y′|≤0.1 that is the difference from output y′=f′(X) of another inference model f′, and the like.

For example, a user uses an input device (not illustrated in FIG. 1) to input a conditional expression or upper and lower limit values of the expected output in text. Thus, the expected output designating unit 23 sets information indicating the conditional expression or the upper and lower limit values input by the input device in the expected output determining unit 24 as the expected output. Further, the expected output designating unit 23 instructs the display processing unit 28 to display, on the screen of the display device 6, a selection screen for selecting a class ID by a drop-down or a check box, or a selection screen for selecting an output range by a parallel coordinate plot. When the user performs a selection operation on the selection screen using the input device, the expected output designating unit 23 receives the selection operation information and sets the selection operation information in the expected output determining unit 24 as an expected output.

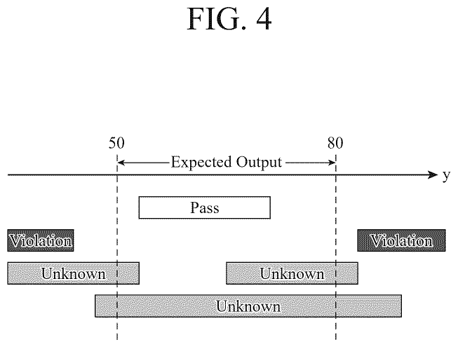

The expected output determining unit 24 determines whether or not all output data of the inference model for the input data area is in violation that the output data is not the expected output. FIG. 4 is a schematic diagram illustrating an outline of the expected output determination, and illustrates a case where the expected output of the regression is 50≤y<80. In FIG. 4, all output data y included in a numerical range of (lower bound of y≥50) & (upper bound of y<80) is also included in the expected output range 50≤y<80, and thus the input data area for the inference model when the output data y is output is not determined to be in violation and is a pass area.

All output data y included in a numerical range of (upper bound of y<50)|(lower bound of y≥80) is not included in the expected output range 50≤y<80, and thus the input data area for the inference model when the output data y is output is a violation area in which determination of violation has been made.

Output data y determined not to be in violation is included in a numerical range not included in any of (lower bound of y≥50) & (upper bound of y<80) and (upper bound of y<50)|(lower bound of y≥80). The expected output determining unit 24 determines that the output data y is included in an unknown area.

In a case where the expected output of binary classification is 1, that is, the output score y is 0.5≤y, all the output scores y included in a score range in which the lower bound≥0.5 of the output score y is included in the expected output range 0.5≤y, and thus the input data area with respect to the inference model when the output score y is output is a pass area.

Since all the output scores y included in a numerical range in which the upper bound<0.5 of the output score y is satisfied are not included in the expected output range 0.5≤y, the input data area for the inference model when the output score y is output is a violation area.

The score range that is not both the lower bound≥0.5 of the output score y and the upper bound<0.5 of the output score y includes the output data y determined not to be in violation. The expected output determining unit 24 determines that the output data y is included in an unknown area.

In a case where the expected output of three-class classification is class 2, that is, (y₁<y₂) & (y₂<y₃), all output data y included in a numerical range of (upper bound of y₁<lower bound of y₂) & (upper bound of y₃<lower bound of y₂) is also included in the expected output range (y₁<y₂) & (y₂<y₃), and thus the input data area for the inference model when the output data y is output is a pass area.

All output data y included in a numerical range of (lower bound of y₁≥upper bound of y₂)|(lower bound of y₃≥upper bound of y₂) is not included in the expected output range (y₁<y₂) & (y₂<y₃), and thus the input data area for the inference model when the output data y is output is a violation area.

Output data y determined not to be in violation is included in a numerical range not included in any of (upper bound of y₁<lower bound of y₂) & (upper bound of y₃<lower bound of y₂) and (lower bound of y₁≥upper bound of y₂)|(lower bound of y₃≥upper bound of y₂). The expected output determining unit 24 determines that the output data y is included in an unknown area.

In a case where |y−y′|≤0.1, which is a difference from the output y′=f′(X) of another inference model f', is an expected output range, all output data y included in the numerical range of (upper bound of y−lower bound of y′≤0.1) & (upper bound of y′−lower bound of y≤0.1) is also included in the expected output range, and thus the input data area for the inference model when the output data y is output is a pass area.

All output data y included in a numerical range of (lower bound of y−upper bound of y′>0.1)|(lower bound of y′−upper bound of y>0.1) is not included in the expected output range |y−y′|≤0.1 and is determined to be in violation, and thus the input data area for the inference model when the output data y is output is a violation area.

Output data y determined to be in violation that the output data is not the expected output is included in a numerical range not included in any of (the upper bound of y−lower bound of y′≤0.1) & (upper bound of y′−lower bound of y≤0.1) and (lower bound of y−upper bound of y′>0.1)|(lower bound of y′−upper bound of y>0.1). The expected output determining unit 24 determines that the output data y is included in an unknown area.

The determination result information of the expected output determining unit 24 is stored in the determination result storage device 5.

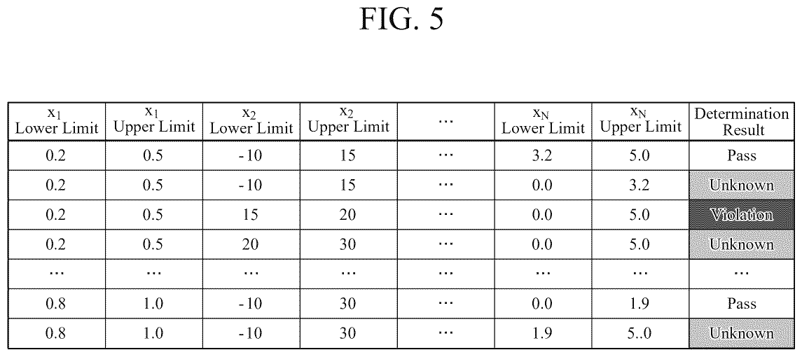

FIG. 5 is a diagram illustrating an example of the expected output determination result, and illustrates the content stored in the determination result storage device 5. As illustrated in FIG. 5, the determination result information includes the input data area and the expected output determination result for each input data. The input data area is a data area defined by a lower limit and an upper limit of each of the input variables x₁, x₂, . . . , x_{N} which are parameters of the relational expression indicating the input data. The expected output determination result is pass, violation, or unknown.

Although the input data corresponding to all the determination results are illustrated, the determination result storage device 5 may store only a specific determination result as the expected output determination result. For example, only input data whose expected output determination result is violation may be stored.

The input area dividing unit 25 divides the area determined not to be in violation in the input data area, and sets the divided area as a new input data area of the inference model. For example, the input area dividing unit 25 may divide the input data area by a branch of a decision tree included in the inference model. In this case, the input area dividing unit 25 divides into overlapping areas of a data area corresponding to each leaf node of the decision tree and the input data area. At this time, the input area dividing unit 25 may ignore a leaf node that cannot be reached in consideration of the constraints of the input data area, or may stop the division at an intermediate branch instead of the leaf node at an end.

In addition, the input area dividing unit 25 may randomly divide the input data area. For example, the input area dividing unit 25 randomly selects an input variable and determines division points within upper and lower limits of the input variable. Furthermore, the input area dividing unit 25 may divide the input data area with reference to a midpoint of the upper and lower limits generated from the uniform distribution, an average value, a median value, or a quantile point of the training data.

The input area dividing unit 25 may weight the selection of the input variable to be divided in accordance with the importance of the feature of the inference model.

Furthermore, the input area dividing unit 25 may divide the input data area by a plurality of division candidates, and may adopt division that gives the best index after the division. For example, the input area dividing unit 25 employs division that minimizes a difference between an upper bound and a lower bound of the inference model output for the divided area.

In addition, the input area dividing unit 25 may adopt division that minimizes the sum of sizes of unknown areas after the division.

The input area dividing unit 25 may continue the division recursively until there is no unknown area, or may terminate the division halfway. For example, the input area dividing unit 25 stops the division in a case where the processing time is equal to or longer than a predetermined value, the number of divided areas is equal to or larger than a predetermined value, the size of the unknown area is less than a predetermined value, or the size of the unknown area is smaller than the size of the violation area.

The input area designating unit 26 sets the input data area in the output upper and lower bound calculating unit 22. The input data area is a data area on an N-dimensional space input to the inference model to be verified. N is an integer. For example, the input data area is table data defined by the input variable x. The input data area may be a feature extracted from an image, a video, a text, an audio, a graph, time-series data, or the like using a neural network or the like.

The input data area may be, for example, S={X=(x₁, x₂, . . . , x_{N})∈R^{N}|−3.5≤x₁≤5.2, . . . , 15≤x_{N}≤40} representing a hyperrectangle, S={X∈R^{N}∥X|²≤r²} representing a hyper-sphere, S=S1∩S2 representing a product set of multiple areas, or S=S1∪S2 representing a union of multiple areas.

For example, the user uses an input device not illustrated in FIG. 1 to input a conditional expression of the input data area or upper and lower limit values of the hyperrectangle in text. Thus, the input area designating unit 26 sets information indicating the conditional expression or upper and lower limit values of the hyperrectangle input with the input device in the output upper and lower bound calculating unit 22 as the input data area. Further, the input area designating unit 26 instructs the display processing unit 28 to display a selection screen for selecting the range of the input variable by a rectangle or a throwing wheel in the two-dimensional space or a selection screen for selecting the range of each input variable by a parallel coordinate plot on the screen of the display device 6. When the user performs a selection operation on the selection screen using the input device, the input area designating unit 26 receives the selection operation information and sets the selection operation information as an input data area in the output upper and lower bound calculating unit 22.

The area ratio calculating unit 27 calculates a ratio of an area for each expected output determination result with respect to the input data area. For example, the area ratio calculating unit 27 may calculate the ratio by the hypervolume of the input data area. When the input data area is a hyperrectangle, the area ratio calculating unit 27 may calculate the ratio of the areas using a product of lengths of sides of the hyperrectangle. In addition, the area ratio calculating unit 27 may calculate the ratio of the area for each expected output determination result to the input data area using the number of data samples of a predetermined data set included in the area.

The area ratio calculating unit 27 may calculate the ratio of the area for each expected output determination result to the input data area using the number of generated data samples included in the area.

The data sample may be generated from a uniform distribution, may be generated by perturbing a data sample of a predetermined data set, may be generated from a data distribution learned from a predetermined data set, or may be generated using a Generative Adversarial Network (GAN) learned from a predetermined data set.

Assuming that the sizes of the violation area, the pass area, and the unknown area are |Sᵥᵢₒₗₐₜᵢₒₙ|, |Sₚₐₛₛ|, and |S_{unknown}|, respectively, the size of the entire input area is obtained from |Sₑₙₜᵢᵣₑ|=|Sᵥᵢₒₗₐₜᵢₒₙ|+|Sₚₐₛₛ|+|S_{unknown}|. In this case, the area ratio calculating unit 27 calculates, for example, |Sᵥᵢₒₗₐₜᵢₒₙ|/|Sₑₙₜᵢᵣₑ|, |Sₚₐₛₛ|/|Sₑₙₜᵢᵣₑ|, |S_{unknown}|/|Sₑₙₜᵢᵣₑ|, |Sᵥᵢₒₗₐₜᵢₒₙ|/(|Sᵥᵢₒₗₐₜᵢₒₙ|+|Sₚₐₛₛ|), or (|Sᵥᵢₒₗₐₜᵢₒₙ|+|S_{unknown}|)/|Sₑₙₜᵢᵣₑ| as a ratio of an area.

The display processing unit 28 is a verification result output unit to output verification result information indicating a ratio of an area. The display processing unit 28 displays the verification result information on the display device 6. The display device 6 is, for example, a liquid crystal display (LCD) or an organic electroluminescence (EL) display device.

The display processing unit 28 outputs display control information for displaying the verification result information to the display device 6. The display device 6 displays the verification result information on the basis of the display control information. For example, the ratio of the area is displayed in a band graph, a circular graph, a stacked bar graph, or color shading.

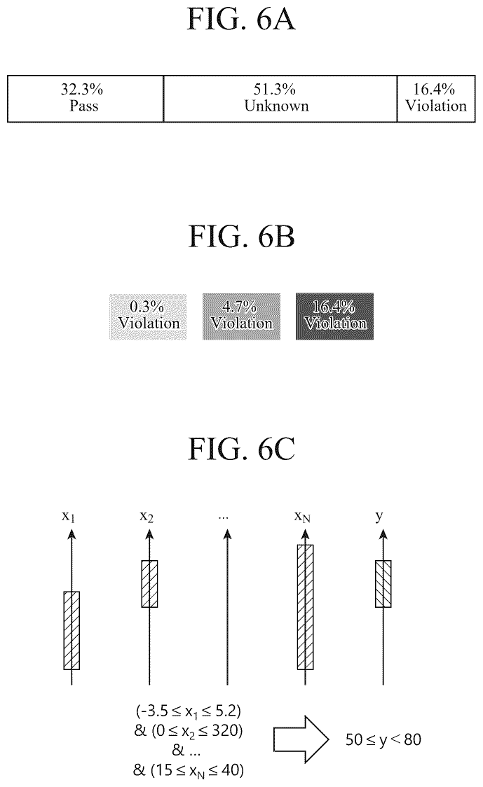

FIG. 6A is a diagram illustrating a display example of a verification result, and illustrates ratios of areas by a band graph. In FIG. 6A, the ratio of an area is represented by the length of a band. The ratio of the pass area is 32.3%, the ratio of the unknown area is 51.3%, and the ratio of the violation area is 16.4%.

FIG. 6B is a diagram illustrating a display example of the verification result, and illustrates ratios of areas by color shading. In FIG. 6B, the ratio of the violation area is represented by color shading. For example, the larger the ratio of violation, the darker the color displayed.

The display processing unit 28 may update the display of the ratio of the area that changes in accordance with the division of the input data area in real time. For example, the display processing unit 28 may monotonically decrease the display of the unknown area or monotonically increase the display of the pass area and the violation area with the lapse of time.

In addition, the display processing unit 28 may display a temporal change of a ratio of an area on the display device 6 as a line graph or animation.

Furthermore, the display processing unit 28 may display the designated input data area and the expected output together on the display device 6. For example, the display processing unit 28 displays the ratio of the area on the display device 6 as a parallel coordinate plot, a two-dimensional plot, or a text.

FIG. 6C is a diagram illustrating a display example of the verification result, and illustrates the ratio of the area by a parallel coordinate plot and text. In FIG. 6C, a numerical range of each of the input variables x₁, x₂, . . . , x_{N} defining the input data area is indicated by a rectangle, and a numerical range of the output data y of the inference model for the input data area is indicated by a rectangle.

Furthermore, the display processing unit 28 may display the numerical range of each of the input variables x₁, x₂, . . . , x_{N} and the numerical range of the output data y as text on the display device 6 as illustrated in FIG. 6.

FIG. 1 illustrates a configuration in which the verification device 2 includes the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28, but is not limited thereto. The verification device 2 only needs to be able to determine the expected output of the inference model, divide the input data area input to the inference model, and output a determination result. Therefore, the configuration other than the expected output determining unit 24, the input area dividing unit 25, and the display processing unit 28 may be included in an external device accessible from the verification device 2.

Note that, although the case where the input data area is an area of a two-dimensional space has been described, the input data area is generally an area of a higher dimensional space of second or higher order.

The inference device 3 is implemented by, for example, a computer including a communication unit, a calculation unit, and a storage unit. The communication unit communicates with the inference model storage device 4 via a wired signal line or a network by wireless communication. For example, the communication unit is a communication device capable of mobile communication by a communication system such as LTE, 3G, 4G, or 5G. In addition, the communication unit may be a short-range wireless communication unit such as Bluetooth (registered trademark).

The calculation unit controls the overall operation of the inference device 3. The calculation unit includes an inference model reading unit 31 and an inference unit 32. Various functions of the inference model reading unit 31 and the inference unit 32 are implemented by the calculation unit executing an information processing application for performing inference.

The storage unit stores, for example, an information processing application and information used for calculation processing of the calculation unit. The storage unit is a storage device included in a computer functioning as the inference device 3, and includes a storage such as an HDD or an SSD, the memory 104 in FIGS. 9A and 9B, or the like. Note that the storage unit only needs to be accessible by the inference device 3, and may be provided outside the inference device 3.

The inference model reading unit 31 reads the inference model verified by the verification device 2 from the inference model storage device 4. The inference model read by the inference model reading unit 31 is set in the inference unit 32.

The inference unit 32 performs inference using the inference model read by the inference model reading unit 31. For example, the inference unit 32 may test a complicated inference model. In this case, in order to make the risk of occurrence of a defect such as a bug in a complex inference model manifest in a test before operation, the inference unit 32 sets a property that is desired to be satisfied at a minimum as an input data area and an expected output in the inference model, and performs inference.

For example, the inference unit 32 sets an area within five minutes on foot from a station and within 10 years from building as an input data area, and infers the rent of an apartment assuming that the expected output of the inference model for this input data area is the rent of 80,000 yen or more.

Further, the inference unit 32 sets a blood pressure equal to or more than 135 and LDL cholesterol equal to or more than 140 as an input data area, and infers necessity of inspection assuming that the expected output of the inference model for this input data area requires inspection.

The inference unit 32 may assume a numerical range indicating a product having a measurement error larger than that of an abnormal product sample as an input data area, and infer abnormality of the product assuming that an expected output is that all products having a measurement error larger than that of the abnormal product sample are abnormal.

Note that if the ratio of the violation area is less than the predetermined value, the inference device 3 is deployed in the actual environment and starts operation.

The inference unit 32 may infer the fidelity of a proxy model approximating a complicated inference model.

For example, the inference device 3 causes the user to recognize behavior at the time of inference by approximation with a single decision tree model having high interpretability. The verification device 2 sets that outputs of the original inference model and the proxy model coincide with each other as the expected output, and calculates the ratio of the violation area in which the outputs of the original inference model and the proxy model do not coincide with each other. Then, the verification device 2 regards the smallness of the violation area ratio as fidelity of the proxy model and displays the fidelity on the display device 6.

The inference of the existing rule-based system may be replaced with the inference model verified by the verification device 2. For example, the existing system is replaced with a machine learning model with high prediction accuracy.

The verification device 2 sets that outputs of the inference model and the existing system match as an expected output, and calculates a ratio of a violation area in which outputs of the inference model and the existing system do not match.

Then, the inference device 3 executes replacement with the inference model in which the violation area ratio is less than the predetermined value.

A difference between two inference models having different versions may be quantified by the verification device 2. For example, a difference between an inference model A learned by data in a certain period and an inference model B learned by data in another period is quantified. The verification device 2 sets that the outputs of the inference model A and the inference model B match as the expected output, and calculates the ratio of the violation area where the outputs of the inference model A and the inference model B do not match. When the violation area ratio is less than the predetermined value, it is regarded that the difference between the model A and the model B is small. Thus, for example, in a system that continuously collects and learns data and updates the inference model, the model can be updated only when the difference between the inference models is small. In addition, by presenting the violation area, it is possible to know in which area the model has a difference, and for example, it is possible to catch and deal with an environmental change such as a data shift at an early stage.

Next, a verification method according to the first embodiment will be described.

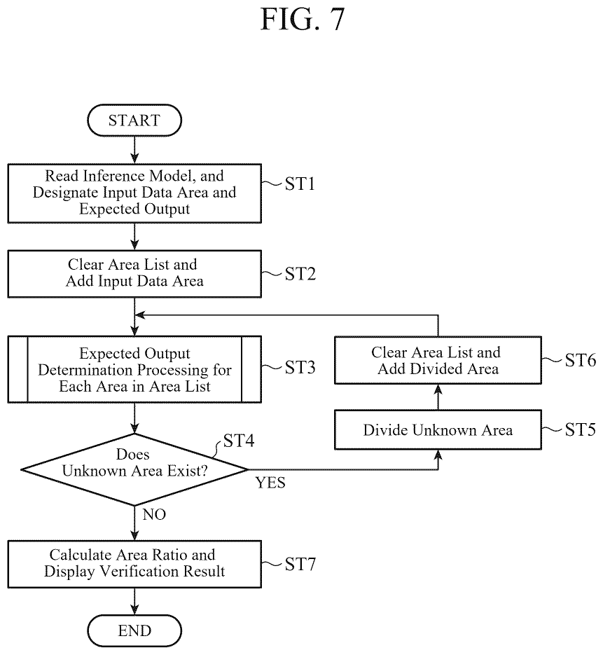

FIG. 7 is a flowchart illustrating the verification method according to the first embodiment.

The inference model reading unit 21 reads the inference model from the inference model storage device 4 and sets the inference model in the output upper and lower bound calculating unit 22, and the input area designating unit 26 sets the input data area in the output upper and lower bound calculating unit 22. The expected output designating unit 23 sets the expected output of the inference model in the expected output determining unit 24. A series of these processes is the process of step ST1.

The expected output determining unit 24 clears an area list and adds the set input data area (step ST2). The area list is a list of data areas input to the inference model. The expected output determining unit 24 inputs the input data area registered in the area list to the inference model.

Next, the expected output determining unit 24 performs expected output determination processing for each input data area in the area list (step ST3).

Subsequently, the expected output determining unit 24 determines whether or not there is an area that is neither a violation area in which all the output data of the inference model for the input data area is not the expected output nor a pass area in which all the output data is the expected output, that is, an unknown area (step ST4).

If there is an unknown area (step ST4; YES), the input area dividing unit 25 divides the unknown area (step ST5). The expected output determining unit 24 clears the area list and adds the divided area as a new input data area of the inference model (step ST6). Subsequently, the expected output determining unit 24 proceeds to step ST3, performs expected output determination of a new input data area, and repeats the subsequent processing.

When there is no unknown area (step ST4; NO), the area ratio calculating unit 27 calculates the ratio of the area for each expected output determination result with respect to the input data area, and subsequently, the display processing unit 28 displays verification result information indicating the ratio of the area on the display device 6 (step ST7).

In this manner, the verification device 2 can present the ratio of the input data area for each determination result of the expected output of the inference model.

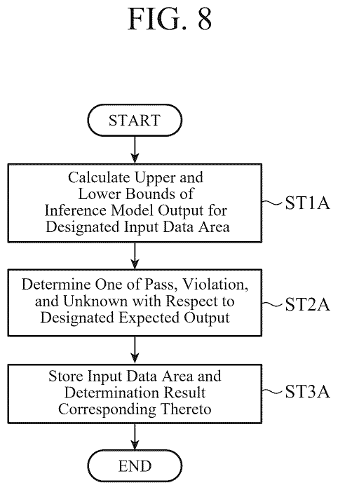

FIG. 8 is a flowchart illustrating the expected output determination processing, and illustrates detailed processing of step ST3 in FIG. 7.

The output upper and lower bound calculating unit 22 calculates upper and lower bounds of the output data of the inference model for the input data area (step ST1A). The output upper and lower bound calculating unit 22 sets the calculated upper and lower bounds of the output data in the expected output determining unit 24.

The expected output determining unit 24 determines whether or not the input data area corresponding to the output data defined in the upper bound and the lower bound of the inference model is determined to be in violation with respect to the expected output designated by the expected output designating unit 23, that is, whether it is violation, or whether it is pass or unknown (step ST2A).

Next, the expected output determining unit 24 stores the input data area and the expected output determination result corresponding thereto in the determination result storage device 5 (step ST3A).

Next, a hardware configuration that implements the functions of the verification device 2 will be described.

The functions of the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28 included in the verification device 2 are implemented by a processing circuit. That is, the verification device 2 includes a processing circuit for executing the processing from step ST1 to step ST7 illustrated in FIG. 7. The processing circuit may be dedicated hardware, or may be a central processing unit (CPU) that executes a program stored in a memory.

FIG. 9A is a block diagram illustrating a hardware configuration that implements the functions of the verification device 2. FIG. 9B is a block diagram illustrating a hardware configuration for executing software for implementing the functions of the verification device 2. In FIGS. 9A and 9B, the input interface 100 is an interface that relays data acquired by the verification device 2 from the inference model storage device 4 or the determination result storage device 5. The output interface 101 is an interface that relays data output from the verification device 2 to the determination result storage device 5.

In a case where the processing circuit is the processing circuit 102 that is dedicated hardware illustrated in FIG. 9A, the processing circuit 102 corresponds to, for example, a single circuit, a composite circuit, a programmed processor, a parallel programmed processor, an application specific integrated circuit (ASIC), a field-programmable gate array (FPGA), or a combination thereof. The functions of the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28 included in the verification device 2 may be implemented by separate processing circuits, or these functions may be collectively implemented by one processing circuit.

In a case where the processing circuit is the processor 103 illustrated in FIG. 9B, the functions of the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28 included in the verification device 2 are implemented by software, firmware, or a combination of software and firmware. Note that the software or firmware is described as a program and stored in the memory 104.

The processor 103 reads and executes the program stored in the memory 104, thereby implementing the functions of the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28 included in the verification device 2. For example, the verification device 2 includes the memory 104 for storing a program that, when executed by the processor 103, results in execution of the processing of steps ST1 to ST7 illustrated in FIG. 7. These programs cause a computer to execute a procedure or a method of processing performed by the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28. The memory 104 may be a computer-readable storage medium storing a program for causing a computer to function as the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28.

The memory 104 corresponds to a nonvolatile or volatile semiconductor memory such as a random access memory (RAM), a read only memory (ROM), a flash memory, an erasable programmable read only memory (EPROM), or an electrically-EPROM (EEPROM) (registered trademark), a magnetic disk, a flexible disk, an optical disk, a compact disk, a mini disk, or a DVD.

A part of the functions of the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28 included in the verification device 2 may be implemented by dedicated hardware, and the other part may be implemented by software or firmware. For example, the functions of the inference model reading unit 21, the output upper and lower bound calculating unit 22, the expected output designating unit 23, and the input area designating unit 26 may be implemented by the processing circuit 102 that is dedicated hardware, and the functions of the expected output determining unit 24, the input area dividing unit 25, the area ratio calculating unit 27, and the display processing unit 28 may be implemented by the processor 103 reading and executing a program stored in the memory 104. As described above, the processing circuit can implement the above functions by hardware, software, firmware, or a combination thereof.

As described above, the verification device 2 according to the first embodiment includes the expected output determining unit 24 to determine whether or not all output data of an inference model for an input data area that is a numerical range of data input to the inference model to be verified is in violation that the output data is not an expected output, the input area dividing unit 25 to divide an area determined not to be in violation in the input data area and set a divided area as the input data area that is new of the inference model, the area ratio calculating unit 27 to calculate a ratio of an area for each of determination results with respect to the input data area, and the display processing unit 28 to display verification result information indicating the ratio of areas on the display device 6. By outputting the ratio of the area for each determination result of the expected output of the inference model, the verification device 2 can present the ratio of the input data area for each determination result of the expected output of the inference model. Thus, it is possible to suppress the degree of violation from being overestimated or underestimated.

Note that, also in the conventional technique described in Patent Literature 1 described above, the input data area is divided into a plurality of areas, and a satisfiability determining unit determines whether there is no satisfiability in any of the divided areas. In a case where it is determined by the satisfiability determination device that there is satisfiability, that is, the satisfiability is indicated, at least one data sample in the divided area is determined to be in violation. Therefore, in the conventional technique described in Patent Literature 1, there is a possibility that an area partially including the data sample determined to be in violation is proposed. On the other hand, the verification device 2 can present the ratio of the input data area for each determination result by dividing the area in which all the output data of the inference model for the input data area is determined not to be in violation, that is, the area including the area including ones determined to pass and ones determined to be in violation.

In the verification device 2 according to the first embodiment, the expected output determining unit 24 determines any one of pass determination where all the output data of the inference model for the input data area is an expected output, violation determination where all the output data of the inference model for the input data area is not an expected output, and unknown determination that corresponds to neither of them. In this manner, the verification device 2 can present the ratio of the input data area for each determination result of the expected output of the inference model.

The verification device 2 according to the first embodiment includes the output upper and lower bound calculating unit 22 to calculate at least one of an upper bound or a lower bound of output data of the inference model for the input data area. The expected output determining unit 24 determines any one of the pass determination, the violation determination, and the unknown determination for an output data area indicated by the upper bound or the lower bound among the output data of the inference model. In this manner, the verification device 2 can present the ratio of the input data area for each determination result of the expected output of the inference model.

In the verification device 2 according to the first embodiment, the inference model to be verified is a decision tree ensemble model including a single decision tree or a plurality of decision trees. The input area dividing unit 25 divides the area in accordance with a branch condition of any decision tree included in the inference model.

Thus, the verification device 2 can determine the expected output of the inference model for each of the divided areas.

The inference device 3 according to the first embodiment includes the inference model reading unit 31 that reads the inference model verified by the verification device 2 and the inference unit 32 that performs inference using the inference model. By presenting the ratio of the input data area for each determination result of the expected output of the inference model, it is possible to suppress the degree of violation from being overestimated or underestimated, so that the inference device 3 can perform highly accurate inference.

The inference system 1 according to the first embodiment includes the verification device 2 and the inference device 3. It is possible to provide an inference system capable of presenting a ratio of an input data area for each determination result of an expected output of an inference model. Thus, it is possible to suppress the degree of violation from being overestimated or underestimated.

The verification method according to the first embodiment includes the steps of: determining, by the expected output determining unit 24, whether or not all output data of an inference model for an input data area is in violation that the output data is not an expected output; dividing, by the input area dividing unit 25, an area determined not to be in violation in the input data area and setting a divided area as a new input data area of the inference model; calculating, by the area ratio calculating unit 27, a ratio of an area for each of determination results with respect to the input data area; and displaying, by the display processing unit 28, verification result information indicating the ratio of the areas on the display device 6. By executing the above method, the verification device 2 can present the ratio of the input data area for each determination result of the expected output of the inference model. Thus, it is possible to suppress the degree of violation from being overestimated or underestimated.

### Second Embodiment

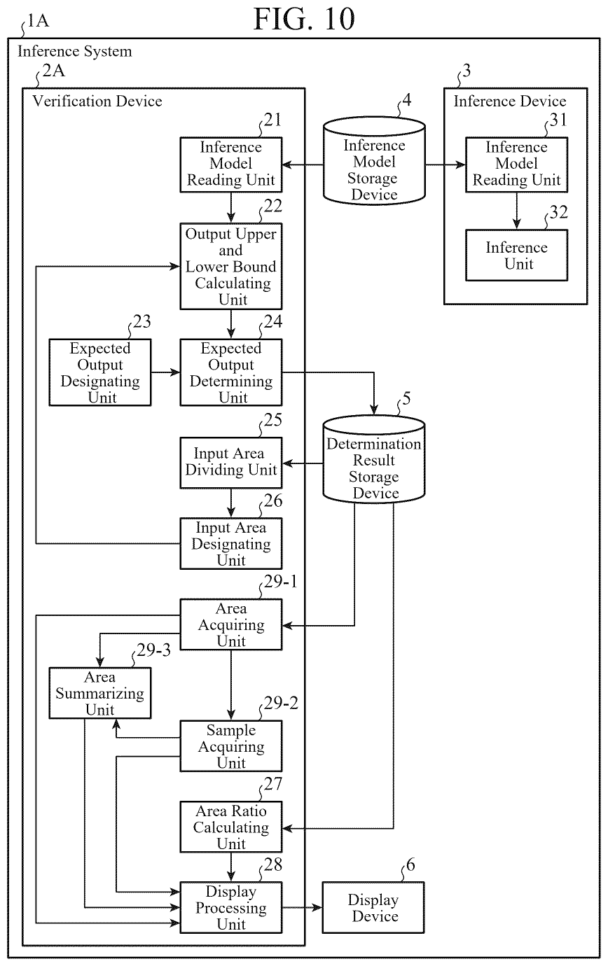

FIG. 10 is a block diagram illustrating a configuration example of an inference system 1A according to a second embodiment. In FIG. 10, the inference system 1A is a system that performs inference using a verified inference model, and includes a verification device 2A, an inference device 3, an inference model storage device 4, a determination result storage device 5, and a display device 6. The verification device 2A is a device that verifies an inference model that is a machine learning model, and the inference device 3 is a device that performs inference using the inference model. The inference system 1 is a system in which the verification device 2, the inference device 3, the inference model storage device 4, the determination result storage device 5, and the display device 6 are connected via a wired signal line or a network by wireless communication. The network is, for example, a telecommunication line including the Internet or the like.

In addition to presentation of an area ratio for each determination result of an expected output of the inference model, the verification device 2A presents an area itself, a data sample included in the area, or summary information of a plurality of areas. The verification device 2A is implemented by, for example, a computer including a communication unit, a calculation unit, and a storage unit. The communication unit communicates with the inference model storage device 4 or the determination result storage device 5 via a wired signal line or a network by wireless communication. For example, the communication unit is a communication device capable of mobile communication by a communication system such as LTE, 3G, 4G, or 5G. In addition, the communication unit may be a short-range wireless communication unit such as Bluetooth (registered trademark). The communication unit includes an input interface 100 and an output interface 101 in FIGS. 9A and 9B.

The calculation unit controls the entire operation of the verification device 2A. The calculation unit includes an inference model reading unit 21, an output upper and lower bound calculating unit 22, an expected output designating unit 23, an expected output determining unit 24, an input area dividing unit 25, an input area designating unit 26, an area ratio calculating unit 27, a display processing unit 28, an area acquiring unit 29-1, a sample acquiring unit 29-2, and an area summarizing unit 29-3. By executing an information processing application for verifying the inference model by the calculation unit, various functions of the inference model reading unit 21, the output upper and lower bound calculating unit 22, the expected output designating unit 23, the expected output determining unit 24, the input area dividing unit 25, the input area designating unit 26, the area ratio calculating unit 27, the display processing unit 28, the area acquiring unit 29-1, the sample acquiring unit 29-2, and the area summarizing unit 29-3 are implemented. The calculation unit includes the processing circuit 102 of FIG. 9A and the processor 103 of FIG. 9B.

The storage unit stores, for example, an information processing application and information used for calculation processing of the calculation unit. The storage unit is a storage device included in a computer functioning as the verification device 2, and includes a storage such as an HDD or an SSD, a memory 104 in FIGS. 9A and 9B, or the like. Note that the storage unit only needs to be accessible by the verification device 2A, and may be provided outside the verification device 2A.

Note that the inference model reading unit 21, the output upper and lower bound calculating unit 22, the expected output designating unit 23, the expected output determining unit 24, the input area dividing unit 25, the input area designating unit 26, the area ratio calculating unit 27, and the display processing unit 28 are similar to those in FIG. 1, and thus redundant description will be omitted.

The area acquiring unit 29-1 acquires the input data area determined by the expected output determining unit 24 from the determination result storage device 5. The display processing unit 28 displays information indicating an area acquired by the area acquiring unit 29-1 on the display device 6.

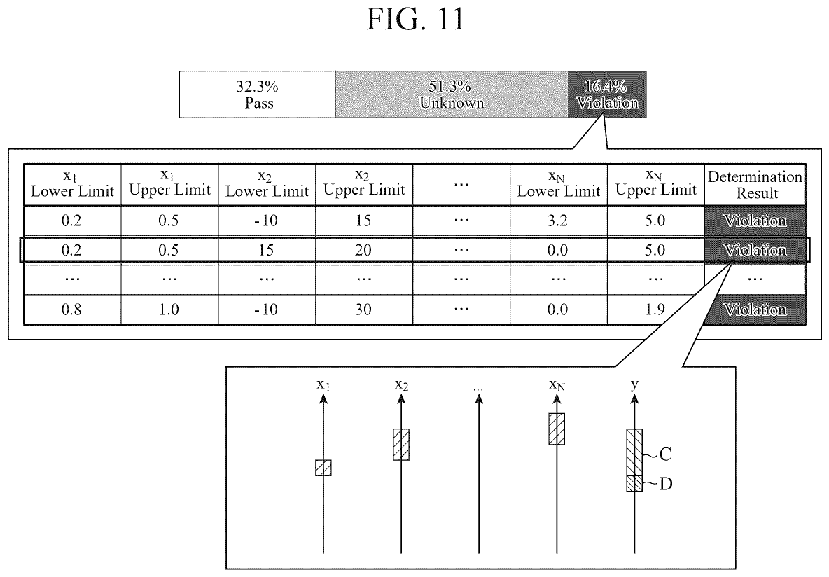

FIG. 11 is a diagram illustrating an acquisition result of a data area of an expected output determination result and a display example thereof. As illustrated in FIG. 11, the information indicating a plurality of input data areas is information indicating the lower limit and the upper limit of each of input variables x₁, x₂, . . . , x_{N} which are parameters of a relational expression indicating each input data area. For example, the area acquiring unit 29-1 acquires information associated with an expected output determination result of violation among information indicating a plurality of input data areas corresponding to expected output determination results of pass, violation, and unknown.

The display processing unit 28 displays the plurality of input data areas corresponding to the expected output determination result of violation on the display device 6 as parallel coordinate plots. In FIG. 11, a numerical range of each of the input variables x₁, x₂, . . . , x_{N} defining any one of the plurality of input data areas corresponding to the expected output determination result of violation is indicated by a rectangle, and a numerical range of output data y of the inference model for this input data area is indicated by a rectangle.

A rectangle C of the output data y of the inference model is a range of the expected output, and a rectangle D of the output data y of the inference model is an output range corresponding to the selected violation area. By referring to these, the user can grasp the degree of violation in the input data.

The sample acquiring unit 29-2 acquires one or more data samples included in the area acquired by the area acquiring unit 29-1. The display processing unit 28 displays the data sample acquired by the sample acquiring unit 29-2 on the display device 6.

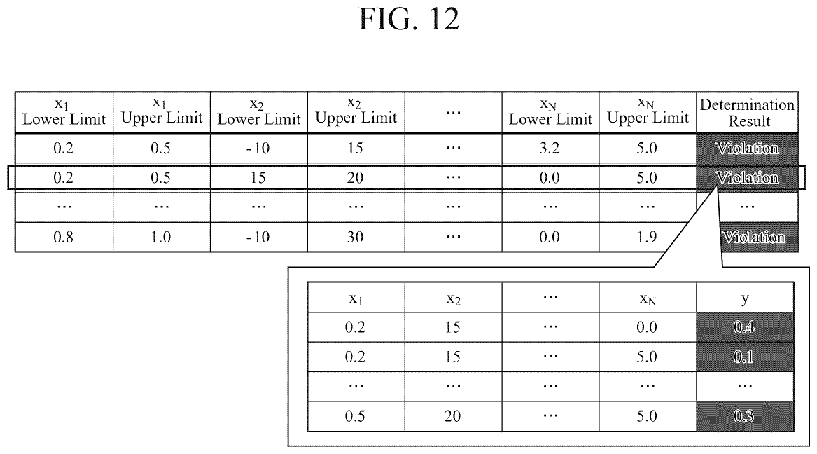

FIG. 12 is a diagram illustrating an acquisition result of a data sample from the data area of the expected output determination result and a display example thereof. For example, as illustrated in FIG. 12, the sample acquiring unit 29-2 acquires, as a data sample, information indicating a lower limit and an upper limit of each of the input variables x₁, x₂, . . . , x_{N} which are parameters of a relational expression indicating one input data area among a plurality of input data areas corresponding to the expected output determination result of violation.

In FIG. 12, in the data sample corresponding to the expected output determination result of violation displayed on the display device 6, for example, the input variable x₁ takes a value between a lower limit 0.2 and an upper limit 0.5. In this manner, the display device 6 displays a plurality of pieces of input data included in one input data area corresponding to the expected output determination result of violation. By referring to these, the user can grasp the input data of the violation area.

As illustrated in FIG. 12, the sample acquiring unit 29-2 acquires a data sample in a case where each variable defining the input data area takes a lower limit value or an upper limit value.

In addition, the sample acquiring unit 29-2 may generate and acquire a data sample from a uniform distribution in the input data area, may acquire a learning data sample included in the input data area, or may acquire a data sample of a vertex of the input data area.

The area summarizing unit 29-3 summarizes the plurality of areas acquired by the area acquiring unit 29-1 into a smaller number of areas. The display processing unit 28 displays, on the display device 6, information indicating an area that has been summarized by the area summarizing unit 29-3.

In a case where the inference model to be verified is a decision tree ensemble model including a single decision tree or a plurality of decision trees, the sample acquiring unit 29-2 acquires one or more data samples included in the area acquired by the area acquiring unit 29-1.

The area summarizing unit 29-3 learns the single decision tree using the data samples acquired by the sample acquiring unit 29-2, and summarizes the area using a leaf node of the learned decision tree.

For example, a case where a violation area is summarized in learning of an inference model including a single decision tree is illustrated. A teacher label “1” is given to a data sample acquired from the violation area, and a teacher label “0” is given to a data sample acquired from a pass area or an unknown area. In addition, it may be included in the teacher label “1” in the data sample acquired from the unknown area. The area summarizing unit 29-3 collects a plurality of determination paths in which the teacher label of the output data is “1” in a decision tree model of a learning result, and sets the corresponding area as a summary area.

Note that a hyperparameter at the time of decision tree learning may be set so as to limit the depth of the decision tree, the maximum value of the number of leaves, the number of data samples included in a leaf, and the like.

Since the area is indicated by simple information by the summary, the user can easily grasp the input data area corresponding to the expected output determination result.

The area summarizing unit 29-3 may weight and learn the data sample acquired by the sample acquiring unit 29-2 with a sample weight proportional to the area size of the input data area that is the acquisition source of the data sample. In this manner, a plurality of input data areas corresponding to the expected output determination result can be presented in the summary area in consideration of the area size, so that the user can easily grasp the input data area corresponding to the expected output determination result.

The area summarizing unit 29-3 outputs the summarized area as a new input data area to the input area designating unit 26. Using the expected output determination result for the summarized area, the area ratio calculating unit 27 may calculate the ratio of any one of areas of pass, violation, and unknown for the summarized area. For example, even if it is displayed that the ratio of the violation area in the original input data area is 0.8%, the degree of violation in the plurality of input data areas including this area cannot be easily grasped. Therefore, by summarizing a plurality of input data areas and displaying that the ratio of the violation area in the summarized area is 93.7%, the user can quantitatively understand the degree of violation in the summarized area.

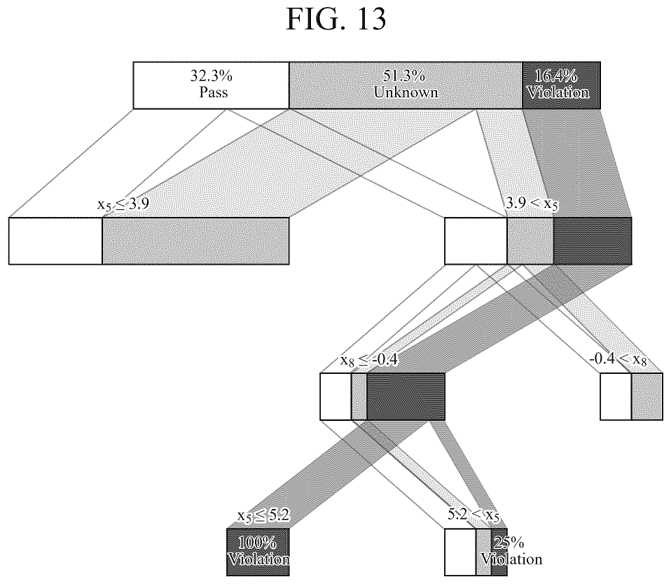

FIG. 13 is a schematic diagram illustrating a display example of the summarized area, and illustrates the area where the summarization has been performed as a parallel category plot of the area ratio. In FIG. 13, the ratio of any one of the areas of pass, violation, or unknown is displayed as band-shaped categories, and the display width of each category is proportional to the area size. The area defined by the input variable x₅ of x₅≤3.9 includes a pass area and an unknown area. On the other hand, the area defined by the input variable x₅ of 3.9<x₅ includes a pass area, an unknown area, and a violation area.

In the area defined by the input variable x₅ of 3.9<x₅, the area defined by the input variable x₈ of x₈≤−0.4 includes a pass area, an unknown area, and a violation area. On the other hand, the area defined by the input variable x₈ of −0.4<x₈ includes a pass area and an unknown area.

In the area defined by the input variable x₈ of x₈≤−0.4, only the violation area is included in the area defined by the input variable x₅ of x₅≤5.2. That is, the ratio of the violation area is 100%. On the other hand, the area defined by the input variable x₅ of 5.2 <x₅ includes a pass area, an unknown area, and a violation area. The ratio of violation area is 25%.

By referring to this display, the user can easily understand the expected output determination result in the summarized area.

As described above, the verification device 2A according to the second embodiment includes the area acquiring unit 29-1 that acquires an input data area determined by the expected output determining unit 24. The display processing unit 28 displays information indicating the acquired area on the display device 6. Since the input data area for each determination result of the expected output of the inference model is displayed, the user can grasp the degree of violation in the input data.

The verification device 2A according to the second embodiment includes the sample acquiring unit 29-2 that acquires one or more data samples included in the area acquired by the area acquiring unit 29-1. The display processing unit 28 displays the acquired data sample on the display device 6. Since the data samples included in the input data area for each determination result of the expected output of the inference model are displayed, the user can grasp the degree of violation in the input data for each data sample.

The verification device 2A according to the second embodiment includes the area summarizing unit 29-3 that summarizes a plurality of areas acquired by the area acquiring unit 29-1 into a smaller number of areas. The display processing unit 28 displays information indicating a summarized area on the display device 6. By displaying areas obtained by summarizing a plurality of input data areas to a smaller number for each determination result of the expected output of the inference model, the user can easily grasp the degree of violation in the input data.

In the verification device 2A according to the second embodiment, the inference model to be verified is a decision tree ensemble model including a single decision tree or a plurality of decision trees. The sample acquiring unit 29-2 that acquires one or more data samples included in an acquired area is provided. The area summarizing unit 29-3 learns a single decision tree using the acquired data samples and summarizes the areas using a leaf node of the learned decision tree. Since the plurality of input data areas for each determination result of the expected output of the inference model is summarized as simple information, the user can easily grasp the degree of violation in the input data.

Note that combinations of the individual embodiments, modifications of any components of the individual embodiments, or omissions of any components in the individual embodiments are possible.

### INDUSTRIAL APPLICABILITY

The verification device according to the present disclosure can be used, for example, for verification of an inference model for performing various inferences.

### REFERENCE SIGNS LIST

1, 1A: Inference system, 2, 2A: Verification device, 3: Inference device, 4: Inference model storage device, 5: Determination result storage device, 6: Display device, 21, 31: Inference model reading unit, 22: Output upper and lower bound calculating unit, 23: Expected output designating unit, 24: Expected output determining unit, 25: Input area dividing unit, 26: Input area designating unit, 27: Area ratio calculating unit, 28: Display processing unit, 29-1: Area acquiring unit, 29-2: Sample acquiring unit, 29-3: Area summarizing unit, 32: Inference unit, 100: Input interface, 101: Output interface, 102: Processing circuit, 103: Processor, 104: Memory

1. A verification device comprising:
processing circuitry
to determine whether or not all output data of an inference model for an input data area that is a numerical range of data is in violation that the output data is not an expected output;
to divide an area determined not to be in violation in the input data area and set a divided area as the input data area that is new of the inference model;
to calculate a ratio of an area for each of determination results with respect to the input data area; and
to output verification result information indicating the ratio of the area.

2. The verification device according to claim 1, wherein
the processing circuitry determines any one of pass determination where all the output data of the inference model for the input data area is an expected output, violation determination where all the output data of the inference model for the input data area is not an expected output, and unknown determination that corresponds to neither of the pass determination or the violation determination.

3. The verification device according to claim 2, wherein
the processing circuitry calculates at least one of an upper bound or a lower bound of output data of the inference model for the input data area, and determines any one of the pass determination, the violation determination, and the unknown determination for an output data area indicated by the upper bound or the lower bound among the output data of the inference model.

4. The verification device according to claim 3, wherein
the inference model to be verified is a decision tree ensemble model including a single decision tree or a plurality of decision trees, and
the processing circuitry divides an area in accordance with a branch condition of any decision tree included in the inference model.

5. The verification device according to claim 1, wherein
the processing circuitry acquires the determined input data area, and
displays information indicating the acquired area on a display device.

6. The verification device according to claim 5, wherein
the processing circuitry acquires one or more data samples included in the acquired area, and
displays the acquired data samples on the display device.

7. The verification device according to claim 5, wherein
the processing circuitry summarizes a plurality of areas acquired into a smaller number of areas, and displays information indicating an area where summarization has been performed on the display device.

8. The verification device according to claim 7, wherein
the inference model to be verified is a decision tree ensemble model including a single decision tree or a plurality of decision trees,
the processing circuitry acquires one or more data samples included in an acquired area, learns the single decision tree using the acquired data samples, and summarizes the areas using a leaf node of the learned decision tree.

9. An inference system comprising:
the verification device according to claim 1; and
an inference device comprising: processing circuitry
to read the inference model verified by the verification device, and
to perform inference using the inference model.

10. A verification method performed by a verification device, the method comprising:
determining whether or not all output data of an inference model for an input data area that is a numerical range of data is in violation that the output data is not an expected output;
dividing an area determined not to be in violation in the input data area, and setting a divided area as the input data area that is new of the inference model;
calculating a ratio of an area for each of determination results with respect to the input data area; and
outputting verification result information indicating the ratio of the area.

11. A non-transitory computer-readable storage medium storing instructions that, when executed by a processor, cause the processor to execute processes comprising:
determining whether or not all output data of an inference model for an input data area that is a numerical range of data is in violation that the output data is not an expected output;
dividing an area determined not to be in violation in the input data area, and setting a divided area as the input data area that is new of the inference model;
calculating a ratio of an area for each of determination results with respect to the input data area; and
outputting verification result information indicating the ratio of the area.
